(19) United States
(12) Patent Application Publication
(10) Pub. No.: US 2005/0273590 A1
(43) Pub. Date: Dec. 8, 2005

(54) Multiple over-clocking main board and control method thereof

(75) Inventor: Kai-Shun Chang, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/142,373

(22) Filed: Jun. 2, 2005

(30) Foreign Application Priority Data
Jun. 4, 2004 (TW) 093116249

(51) Int. Cl. G06F 1/04

(52) U.S. Cl. 713/100; 713/600

(57) ABSTRACT

A multiple over-clocking main board includes a CPU, a chipset and a clock-rate control-signal generating module. The CPU outputs a clock control signal. The chipset at least has a FSB circuit electrically connected to the CPU, and a PCIE bus circuit electrically connected to the FSB circuit. The clock-rate control-signal generating module electrically connected to the chipset generates a clock-rate control signal, which is inputted to the chipset. The chipset resets a transmission frequency ratio of an information transmission frequency of the FSB circuit to that of the PCIE bus circuit according to the clock-rate control signal.

### BACKGROUND OF THE INVENTION

1. Field of Invention

The invention relates to a multiple over-clocking main board and a control method thereof, and more particularly to a multiple over-clocking main board free from the system instability caused by the working clock mismatch, and a control method thereof.

2. Related Art

With the progress of the computer technology, the computer including a CPU, a main board, a memory, and the likes, has the gradually increased processing and operating speeds. The product with the higher processing speed always has a higher price. However, when a product is used, a limit of the product will not be achieved under various considerations. In other words, the product should have better application options. Hence, the over-clocking technology has been utilized to achieve a greater efficiency of the computer product with a lower price.

Referring to FIG. 1, for example, a main board mainly includes a CPU (Central Processing Unit) 11, a clock generating module 12, a north bridge chipset 13 that at least has a FSB (Front Side Bus) circuit 131 and a PCIE (Peripheral Component Interface Express) bus circuit 132, and a south bridge chipset 14. The CPU 11 transmits at least one clock control signal S₀ to the clock generating module 12 such that the clock generating module 12 outputs a first clock signal CK₀ and a second clock signal CK₁. The first clock signal CK₀ is inputted to the CPU 11 and the FSB circuit 131 of the north bridge chipset 13, and the second clock signal CK₁ is inputted to the PCIE bus circuit 132 of the north bridge chipset 13 and the south bridge chipset 14.

The conventional over-clocking technology can increase the frequency of the first clock signal CK₀ within the allowable range of the CPU 11 without increasing the frequency of the second clock signal CK₁. For example, the first clock signal CK₀ may be increased to FSB 200, FSB 201, FSB 202, or even FSB 1200 that has a working frequency of 300 MHz. However, the second clock signal CK₁ at this time is still held at the working frequency of the PCIE 100 without increasing the working frequency thereof.

In addition, in the products before Intel 915 (Grantsdale) north bridge chipset and 925 (Alderswood) north bridge chipset, as long as the over-clocking range is under the allowable working frequency of the CPU, the system is free from the unstable condition by only over-clocking the information transmission frequency between the CPU and the north bridge chipset without over-clocking the information transmission frequency between the north bridge chipset and the south bridge chipset and its peripheral PCIE (S-PCIE-1 to S-PCIE-n and N-PCIE shown in FIG. 1). However, after Intel 915 and 925 north bridge chipsets are invented, the system will be unstable when the ratio of the working frequency of the first clock signal CK₀ to the second clock signal CK₁ after over-clocking exceeds a predetermined value.

Recently, another over-clocking technology has been developed. As shown in FIG. 1, the frequency of the second clock signal CK₁ is increased according to a ratio while the frequency of the first clock signal CK₀ is increased within the allowable range of the CPU 11. For example, the first clock signal CK₀ may be FSB 133 MHz, FSB 137 MHz, FSB 140 MHz and FSB 150 MHz. At this time, the working frequency corresponding to the second clock signal CK₁ is PCIE 100 MHz, or the working frequency above PCIE 100 MHz.

Although it is possible to solve the problem of system instability caused by the working clock mismatch when the ratio of the working frequency of the first clock signal CK₀ to that of the second clock signal CK₁ exceeds the predetermined value, another problem arises. The arisen problem is that the information transmission frequency between the north bridge chipset and the south bridge chipset and its peripheral PCIE (S-PCIE-1 to S-PCIE-n and N-PCIE as shown in FIG. 1) has a maximum limit. For example, when the value of the second clock signal is above PCIE 116 MHz and if the first clock signal is again over-clocked to FSB 160 MHz and the value of the second clock signal is continuously increased over PCIE 116 MHz, the interface connected to the PCIE cannot match with the transmission frequency ratio of the information transmission frequency of the FSB circuit 131 to the information transmission frequency of the PCIE bus circuit 132.

As mentioned above, after Intel 915 and 925 chipsets are employed, the computer product cannot achieve its maximum efficiency due to the system instability caused by the working clock mismatch when the ratio of the working frequency of the first clock signal to that of the second clock signal exceeds a predetermined value. Hence, it is an important subjective to make the computer product achieve its maximum efficiency in the main board over-clocking technology.

### SUMMARY OF THE INVENTION

In view of the foregoing, the invention is to provide a multiple over-clocking main board free from the system instability caused by the working clock mismatch, and a control method thereof.

To achieve the above, a multiple over-clocking main board of the invention includes a CPU, a chipset and a clock-rate control-signal generating module. The CPU outputs a clock control signal. The chipset at least has a FSB circuit and a PCIE bus circuit. The FSB circuit is electrically connected to the PCIE bus circuit and the CPU. The clock-rate control-signal generating module electrically connected to the chipset generates a clock-rate control signal, which is inputted to the chipset. The chipset resets a transmission frequency ratio of an information transmission frequency of the FSB circuit to an information transmission frequency of the PCIE bus circuit according to the clock-rate control signal.

In addition, the invention also discloses a method for controlling a multiple over-clocking main board, wherein the multiple over-clocking main board comprises a CPU (Central Processing Unit), a clock generating module, a clock-rate control-signal generating module, and a chipset comprising a FSB (Front Side Bus) circuit and a PCIE (Peripheral Component Interface Express) bus circuit. The method comprising the following steps of: generating clock information and inputting the clock information to the CPU, such that the CPU transmits a clock control signal to the clock generating module according to the clock information; enabling the clock generating module to generate a first clock signal and a second clock signal according to the clock control signal, to input the first clock signal to the CPU and the FSB circuit of the chipset, and to input the second clock signal to the PCIE bus circuit of the chipset; generating clock-rate information and inputting the clock-rate information to the clock-rate control-signal generating module, such that the clock-rate control-signal generating module generates a clock-rate control signal according to the clock-rate information; and inputting the clock-rate control signal to the chipset, such that the chipset resets a transmission frequency ratio of an information transmission frequency of the FSB circuit to an information transmission frequency of the PCIE bus circuit according to the clock-rate control signal.

As mentioned above, the multiple over-clocking main board of the invention utilizes a clock-rate control-signal generating module to generate a clock-rate control signal to be transmitted to the chipset, so the chipset can change its recognized configuration according to the clock-rate control signal. Thus, the system instability caused by the working clock mismatch can be avoided such that the computer product can achieve its maximum efficiency.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional over-clocking main board;

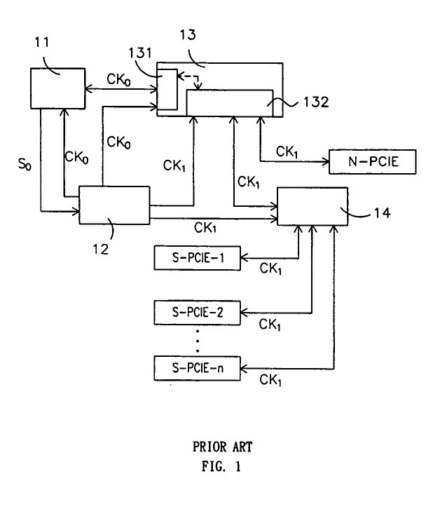

FIG. 2 is a schematic illustration showing a multiple over-clocking main board according to a preferred embodiment of the invention;

FIG. 3 is a schematic illustration showing another multiple over-clocking main board according to the preferred embodiment of the invention; and

FIG. 4 is a flow chart showing a method for controlling the multiple over-clocking main board according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

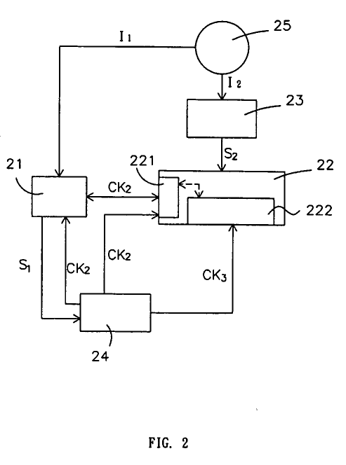

Referring to FIG. 2, a multiple over-clocking main board according to the preferred embodiment of the invention includes a CPU (Central Processing Unit) 21, a chipset 22, a clock-rate control-signal generating module 23, a clock generating module 24 and a BIOS (Basic Input/Output System) module 25. In this embodiment, the CPU 21 outputs a clock control signal S₁ to the clock generating module 24.

The chipset 22 at least has a FSB (Front Side Bus) circuit 221 and a PCIE (Peripheral Component Interface Express) bus circuit 222. The FSB bus circuit 221 is electrically connected to the PCIE bus circuit 222 and the CPU 21. In this embodiment, the chipset 22 is a north bridge chipset.

The clock-rate control-signal generating module 23 is electrically connected to the chipset 22 and generates a clock-rate control signal S₂, which is inputted to the chipset 22. The chipset 22 resets a transmission frequency ratio of the information transmission frequency of the FSB circuit 221 to the information transmission frequency of the PCIE bus circuit 222 according to the clock-rate control signal S₂.

The clock generating module 24 is electrically connected to the CPU 21, the FSB circuit 221 and the PCIE bus circuit 222. The clock generating module 24 outputs a first clock signal CK₂ and a second clock signal CK₃. In this embodiment, the first clock signal CK₂ is inputted to the CPU 21 and the FSB circuit 221, and the second clock signal CK₃ is inputted to the PCIE bus circuit 222. The frequency of the first clock signal CK₂ equals the information transmission frequency of the FSB circuit 221, and the frequency of the second clock signal CK₃ equals the information transmission frequency of the PCIE bus circuit 222.

The BIOS module 25 is electrically connected to the CPU 21 and the clock-rate control-signal generating module 23. The BIOS module 25 outputs clock information I₁ and clock-rate information I₂. In this embodiment, the clock information I₁ is inputted to the CPU 21, which generates a clock control signal S₁ according to the clock information I₁. In addition, the clock-rate information I₂ is inputted to the clock-rate control-signal generating module 23, which generates a clock-rate control signal S₂ according to the clock-rate information I₂. In this embodiment, the clock-rate control-signal generating module 23 further includes a rate look-up table and at least one register. When the BIOS module 25 outputs the clock-rate information I₂ to the clock-rate control-signal generating module 23, the clock-rate control signal S₂ corresponding to the clock-rate information I₂ is selected from the rate look-up table and stored in the register.

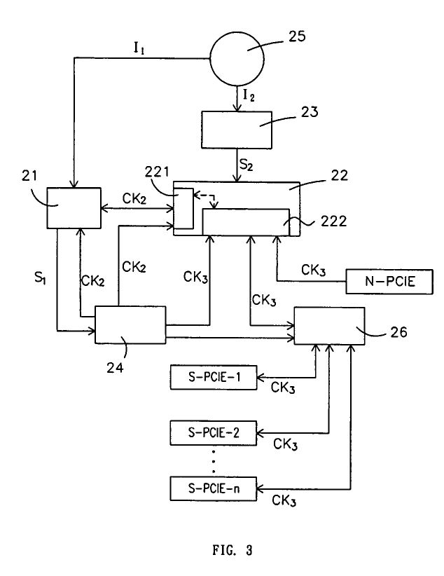

In this embodiment, the multiple over-clocking main board further includes a south bridge chipset 26. As shown in FIG. 3, the south bridge chipset 26 is electrically connected to the clock generating module 24 and the PCIE bus circuit 222. The clock generating module 24 generates a second clock signal CK₃ to be inputted to the south bridge chipset 26, and the frequency of the second clock signal CK₃ equals the information transmission frequency between the PCIE bus circuit 222 and the south bridge chipset 26 and its peripheral PCIE (S-PCIE-1 to S-PCIE-n and N-PCIE as shown in FIG. 3).

A method for controlling the multiple over-clocking main board according to the preferred embodiment of the invention will be described with reference to an example.

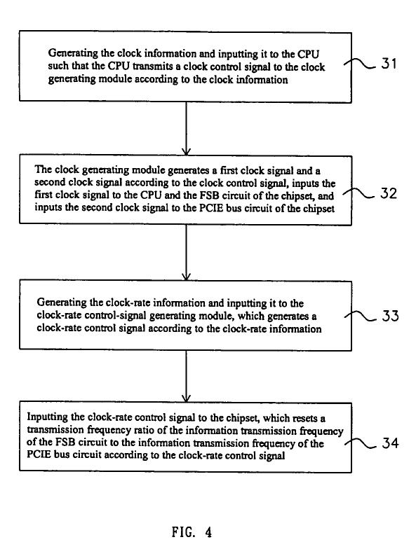

The method for controlling a multiple over-clocking main board according to the preferred embodiment of the invention will be described with reference to FIG. 4 in view of FIG. 3. The multiple over-clocking main board includes a CPU 21, a chipset 22 that at least has a FSB circuit 221 and a PCIE bus circuit 222, a clock-rate control-signal generating module 23, a clock generating module 24, a BIOS module 25 and a south bridge chipset 26. The method for controlling the multiple over-clocking main board includes the following steps 31 to 34.

The clock information I₁ is generated and inputted to the CPU 21 such that the CPU 21 transmits a clock control signal S₁ to the clock generating module 24 according to the clock information I₁ (step 31). The clock information I₁ is outputted to the CPU 21 from the BIOS module 25. In this embodiment, the clock information I₁ is the information having the FSB 140 specification.

The clock generating module 24 generates a first clock signal CK₂ and a second clock signal CK₃ according to clock control signal S₁, inputs the first clock signal CK₂ to the CPU 21 and the FSB circuit 221 of the chipset 22, and inputs the second clock signal CK₃ to the PCIE bus circuit 222 of the chipset 22 (step 32). In this embodiment, the chipset 22 is a north bridge chipset, the first clock signal CK₂ is a frequency signal of the FSB 140 specification, and the second clock signal CK₃ is a frequency signal of the PCIE 108 specification.

Then, clock-rate information I₂ is generated and inputted to the clock-rate control-signal generating module 23, which generates a clock-rate control signal S₂ according to the clock-rate information I₂ (step 33). The clock-rate information I₂ is inputted to the clock-rate control-signal generating module 23 from the BIOS module 25. In this embodiment, the clock-rate control signal is a signal with a ratio of 4:3.

Next, the clock-rate control signal S₂ is inputted to the chipset 22, which resets a transmission frequency ratio of the information transmission frequency of the FSB circuit 221 to the information transmission frequency of the PCIE bus circuit 222 according to the clock-rate control signal S₂ (step 34). In this embodiment, the transmission frequency ratio of the information transmission frequency of the FSB circuit 221 to the information transmission frequency of the PCIE bus circuit 222 is 4:3 ,which is specified in Intel 915 and Intel 925 chipsets.

In this embodiment, the first clock signal CK₂, which has a frequency of the FSB 140 specification, equals the information transmission frequency of the FSB circuit 221. The second clock signal CK₃, which has a frequency of the PCIE 108 specification, equals the information transmission frequency between the PCIE bus circuit 222 and the south bridge chipset 26 and its peripheral PCIE (S-PCIE-1 to S-PCIE-n and N-PCIE as shown in FIG. 2).

In addition, if the clock information I₁ is the information of the FSB 170 specification in this embodiment, the clock-rate control-signal generating module 23 receives another clock-rate information I₂. At this time, the PCIE specification will exceed the specification of the original ratio of 4:3, so the clock-rate control-signal generating module 23 generates another clock-rate control signal S₂ with a ratio of 2:1 ,and outputs the clock-rate control signal S₂ to the chipset 22. The chipset 22 sets the transmission frequency ratio of the information transmission frequency of the FSB circuit 221 to the information transmission frequency of the PCIE bus circuit 222 to be 2:1. Then, the clock generating module 24 outputs another first clock signal CK₂, which is a frequency signal of the FSB 170 specification, and another second clock signal CK₃, which is a frequency signal of the PCIE 85 specification. Herein, the working clock of the main board may be matched, and the system instability caused by the working clock mismatch can be avoided.

As mentioned above, in the method for controlling the multiple over-clocking main board of the invention, the first clock signal CK₂ may have the specification of FSB 133, FSB 137, FSB 140, FSB 150, FSB 160, FSB 170, FSB 180, FSB 190, FSB 200, or the likes, and the second clock signal CK₃ corresponding thereto may have the specification of PCIE 100, PCIE 100, PCIE 108, PCIE 116, PCIE 82.5, PCIE 85, PCIE 90, PCIE 95, PCIE 100, or the likes. It can be observed, from the above-mentioned proportional relationship, that the ratio of the first clock signal CK₂ to the second clock signal CK₃ is about 4:3 when the employed specification is older than the specifications of FSB 150 and PCIE 116. When the FSB specification reaches FSB 160, the ratio of the first clock signal CK₂ to the second clock signal CK₃ is shifted to about 2:1, such that the PCIE specification is still within the specification. Of course, the proportional relationship between the first clock signal CK₂ and the second clock signal CK₃ also may be adjusted according to the actual situation.

In summary, the multiple over-clocking main board of the invention and the control method thereof output the required clock signal according to the specification specified by the clock information, and have an additional clock-rate control-signal generating module for setting the proportional configuration specified by the chipset. Therefore, it is possible to prevent the system instability caused by the working clock mismatch, and the computer product can achieve its maximum efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A multiple over-clocking main board, comprising:
a CPU (Central Processing Unit) outputting a clock control signal;
a chipset comprising a FSB (Front Side Bus) circuit electrically connected to the CPU, and a PCIE (Peripheral Component Interface Express) bus circuit electrically connected to the FSB circuit; and
a clock-rate control-signal generating module electrically connecting to the chipset and generating a clock-rate control signal, wherein the clock-rate control signal is inputted to the chipset, and the chipset resets a transmission frequency ratio of an information transmission frequency of the FSB circuit to an information transmission frequency of the PCIE bus circuit according to the clock-rate control signal.

2. The multiple over-clocking main board according to claim 1, further comprising:
a clock generating module electrically connecting to the CPU, the FSB circuit and the PCIE bus circuit, wherein the clock generating module outputs a first clock signal and a second clock signal.

3. The multiple over-clocking main board according to claim 2, wherein the first clock signal is inputted to the CPU and the FSB circuit, and a frequency of the first clock signal is equal to the information transmission frequency of the FSB circuit.

4. The multiple over-clocking main board according to claim 2, wherein the second clock signal is inputted to the PCIE bus circuit, and a frequency of the second clock signal is equal to the information transmission frequency of the PCIE bus circuit.

5. The multiple over-clocking main board according to claim 1, further comprising:
a BIOS (Basic Input/Output System) module electrically connecting to the CPU and the clock-rate control-signal generating module, and outputs clock information and clock-rate information.

6. The multiple over-clocking main board according to claim 5, wherein the clock information is inputted to the CPU, and the CPU generates the clock control signal according to the clock information.

7. The multiple over-clocking main board according to claim 5, wherein the clock-rate information is inputted to the clock-rate control-signal generating module, and the clock-rate control-signal generating module generates the clock-rate control signal according to the clock-rate information.

8. The multiple over-clocking main board according to claim 1, wherein the chipset is a north bridge chipset.

9. A method for controlling a multiple over-clocking main board, wherein the multiple over-clocking main board comprises a CPU (Central Processing Unit), a clock generating module, a clock-rate control-signal generating module, and a chipset comprising a FSB (Front Side Bus) circuit and a PCIE (Peripheral Component Interface Express) bus circuit, the method comprising the steps of:
generating clock information and inputting the clock information to the CPU, such that the CPU transmits a clock control signal to the clock generating module according to the clock information;
enabling the clock generating module to generate a first clock signal and a second clock signal according to the clock control signal, to input the first clock signal to the CPU and the FSB circuit of the chipset, and to input the second clock signal to the PCIE bus circuit of the chipset;
generating clock-rate information and inputting the clock-rate information to the clock-rate control-signal generating module, such that the clock-rate control-signal generating module generates a clock-rate control signal according to the clock-rate information; and
inputting the clock-rate control signal to the chipset, such that the chipset resets a transmission frequency ratio of an information transmission frequency of the FSB circuit to an information transmission frequency of the PCIE bus circuit according to the clock-rate control signal.

10. The method according to claim 9, wherein the multiple over-clocking main board further comprises a BIOS (Basic Input/Output System) module and the method further comprises:
enabling the BIOS (Basic Input/Output System) module to output the clock information to the CPU, and to output the clock-rate information to the clock-rate control-signal generating module.
